(19) United States
(12) Patent Application Publication
(10) Pub. No.: US 2012/0011964 A1
(43) Pub. Date: Jan. 19, 2012

(54) INDEXING APPARATUS FOR MACHINE TOOL

(75) Inventor: Yoshinori TATSUDA, KANAZAWA-SHI (JP)

(73) Assignee: TSUDAKOMA KOGYO KABUSHIKI KAISHA, KANAZAWA-SHI (JP)

(21) Appl. No.: 13/156,956

(22) Filed: Jun. 9, 2011

(30) Foreign Application Priority Data
Jul. 15, 2010 (JP) 2010-160763

(51) Int. Cl. B23Q 16/10

(52) U.S. Cl. 74/813 R

(57) ABSTRACT

A slide disk that is displaceable when the slide disk is bent toward a base section of a frame is provided at a main shaft, and a friction surface that can contact a pressing portion of the slide disk is provided at the base section. The pressing portion of the slide disk normally presses the friction surface to cause the pressing portion of the slide disk to normally press the friction surface, and hence a pressing force for applying to the main shaft a rotational resistance that permits rotation of the main shaft normally acts on the main shaft. Accordingly, even if the position of the center of gravity of a member to be rotated is deviated from a rotation axis of the main shaft, the rotational resistance can be applied to the main shaft.

### BACKGROUND OF THE INVENTION

1. Field of the Invention

The present invention relates to an indexing apparatus for a machine tool. In particular, the invention is preferably used for an indexing apparatus that indexes an angular position of a main shaft (or a circular table) that supports a rotation target member (for example, a circular table of a rotary table device) by rotationally driving the main shaft with a direct drive motor.

2. Description of the Related Art

As an indexing apparatus used for a machine tool, there has been known a rotary table device that fixes a circular table, on which a workpiece (an object to be processed) is placed, to a main shaft, and rotates the circular table by rotationally driving the main shaft. The rotary table device indexes an angular position of the circular table by rotationally driving the main shaft, and is used to process the workpiece at the indexed angular position. This kind of indexing apparatus includes a clamp device for holding the circular table at the indexed angular position (an indexed position).

The clamp device brings the main shaft (the circular table) into a rotation-inhibited state at the indexed position. There are three types of clamp devices including coupling type, disk type, and sleeve type. The coupling type stops rotation of the main shaft by a coupling portion such as a claw coupling. The disk type brings a brake plate (a clamp disk), which is parallel to the circular table, into contact with an end surface of the main shaft, presses the clamp disk to generate a friction, and stops the rotation of the main shaft by the friction. The sleeve type brings a clamp sleeve into contact with an outer peripheral surface of the main shaft to generate a friction, and stops the rotation of the main shaft by the friction.

One of arts relating to the indexing apparatus including the clamp device may be an indexing apparatus described in Japanese Unexamined Patent Application Publication No. 2007-125640 (hereinafter, referred to as document '640). The indexing apparatus described in the document '640 uses, as a driving unit for a circular table, a direct drive motor (hereinafter, referred to as DD motor) that rotationally drives a main shaft without a drive transmitting portion such as a worm gear. In the document '640, a sleeve clamp device (a first holding device) for holding a stop position brings a clamp sleeve, which is deformed in a direction in which an inner diameter of the clamp sleeve is decreased by action of a pressurized fluid, into contact with an outer peripheral surface of the main shaft, which is rotationally driven by the DD motor to generate a friction; and applies a rotational resistance, which inhibits the main shaft (the circular table) from rotating, to the main shaft by the friction; and hence brings the main shaft into a rotation-inhibited state.

The clamp device described in the document '640 is a fluid-pressure-operation clamp device that generates a holding force by supplying the pressurized fluid. In other words, the clamp device applies a rotational resistance, which inhibits the main shaft from rotating, to the main shaft such that the pressurized fluid can be supplied, i.e., such that power feed to a power unit that drives a clamp member is available.

An indexing apparatus using a worm gear typically has a self-locking function that does not transmit rotation from an output side (a worm wheel side) to an input side (a worm side). In contrast, the indexing apparatus that rotationally drives the main shaft with the DD motor does not have the above-mentioned self-locking function. Hence, if power feed to a machine tool is cut because of a power failure or the like, and the powder feed to the power unit that drives the clamp member of the clamp device is stopped, the holding force by the clamp device is lost, and consequently the main shaft becomes freely rotatable.

Meanwhile, for example, if the indexing apparatus is installed such that the rotation axis of the main shaft is aligned with the substantially horizontal direction (i.e., vertical installation), when a member to be rotated such as a workpiece is attached to the circular table, which is the rotation target member, the position of the center of gravity of the member to be rotated is deviated from the rotation axis of the main shaft, and the member to be rotated may frequently apply a force in a rotation direction to the main shaft because of the influence of the gravity. In this case, if the clamp device loses the holding force and the main shaft becomes freely rotatable as described above, the main shaft is rotated by a rotational force caused by the deviation of the center of gravity, and the member to be rotated supported by the main shaft through the circular table may be unintentionally rotated. Then, depending on a tilt angle of the circular table or the workpiece at this time, the workpiece may collide with part of the machine tool or a tool located near the workpiece and may be broken. Also, if the workpiece collides with the tool because the workpiece is unintentionally rotated, not only the workpiece but also the tool may be broken.

To address these problems, the indexing apparatus described in the document '640 further includes another clamp device (a second holding device) that applies a holding force to the main shaft when the power feed to the power unit is stopped, in addition to the clamp device (the first holding device) that indexes the angular position of the main shaft. The second holding device may be, for example, a non-exited-operation brake that is in an unclamping state when power is fed to the power unit and is changed to a clamping state when power is not fed to the power unit.

With the indexing apparatus described in the document '640, even if the power feed to the power unit that drives the clamp member, which is the first holding device, is stopped by the power failure or the like and the holding force by the first holding device is lost, the second holding device is operated, and the holding force by the second holding device acts on the main shaft. However, a time is required when the second holding device is completely changed to the clamping state although the time is short. A delay may be generated from when the holding force by the first holding device is lost to when the second holding device holds the main shaft. Hence, the main shaft may be freely rotated during the delay time, and the workpiece and the tool may be broken.

### SUMMARY OF THE INVENTION

The present invention is made to address these problems and an object of the invention is, if power feed to a power unit that drives a clamp member of a clamp device is stopped, to prevent a main shaft from being freely rotated while a rotational resistance does not properly act, and to prevent a workpiece or a tool from being broken.

To address the above-described problems, an indexing apparatus for a machine tool according to an aspect of the present invention includes a frame; a main shaft that is supported rotatably relative to the frame; a direct drive motor that rotationally drives the main shaft; and a rotational resistance applying device that applies a rotational resistance to the main shaft, the rotational resistance permitting rotation of the main shaft. The rotational resistance applying device includes a friction surface that is provided at one of the frame and the main shaft, a pressing member that is provided at the other one of the frame and the main shaft to face the friction surface, and an urging portion that urges the pressing member to the friction surface and hence causes the pressing member to normally press the friction surface.

With the above configuration, since the rotational resistance normally acts on the main shaft, if power feed to a power unit that drives a clamp member is stopped, a resistance can be applied to rotation of the main shaft generated due to deviation of the center of gravity of a rotation target member with respect to a rotation axis of the main shaft without a delay after the powder feed stop. Accordingly, the main shaft is prevented from being freely rotated at high speed while the rotational resistance does not properly act, and a workpiece or a tool can be prevented from being broken.

### BRIEF DESCRIPTION OF THE DRAWINGS

FIG. 1 illustrates an example of a rotary table device that is vertically installed as part of a cradle indexing apparatus according to an embodiment of the invention;

FIG. 2 illustrates a configuration example of the indexing apparatus according to the embodiment of the invention;

FIG. 3 illustrates a configuration example of part of a rotational resistance applying device according to the embodiment of the invention;

FIG. 4 illustrates another configuration example of part of the rotational resistance applying device according to the embodiment of the invention;

FIG. 5 illustrates a configuration example of an indexing apparatus according to another embodiment of the invention;

FIG. 6 illustrates a configuration example of part of a rotational resistance applying device according to the another embodiment of the invention;

FIG. 7 illustrates another configuration example of part of the rotational resistance applying device according to the another embodiment of the invention;

FIG. 8 illustrates still a configuration example of an indexing apparatus according to still another embodiment of the invention;

FIG. 9 illustrates a configuration example of part of a rotational resistance applying device according to the still another embodiment of the invention; and

FIG. 10 illustrates another configuration example of part of the rotational resistance applying device according to the still another embodiment of the invention.

### DESCRIPTION OF THE PREFERRED EMBODIMENTS

An embodiment of the present invention will be described below with reference to the accompanying drawings. This embodiment is an example when the invention is applied to a rotary table device vertically installed as part of a cradle indexing apparatus. In the following description, it is assumed that an “axial direction” represents a rotation direction of a rotation axis 205 of a main shaft 4a, and a “radial direction” represents a radial direction of the main shaft 4a and a circular table 5 that are coaxially arranged. Also, for the convenience of description, an upper side (an upper end, an upper surface) represents a side of each member the side which is located near the circular table 5, and a lower side (a lower end, a lower surface) represents the opposite side.

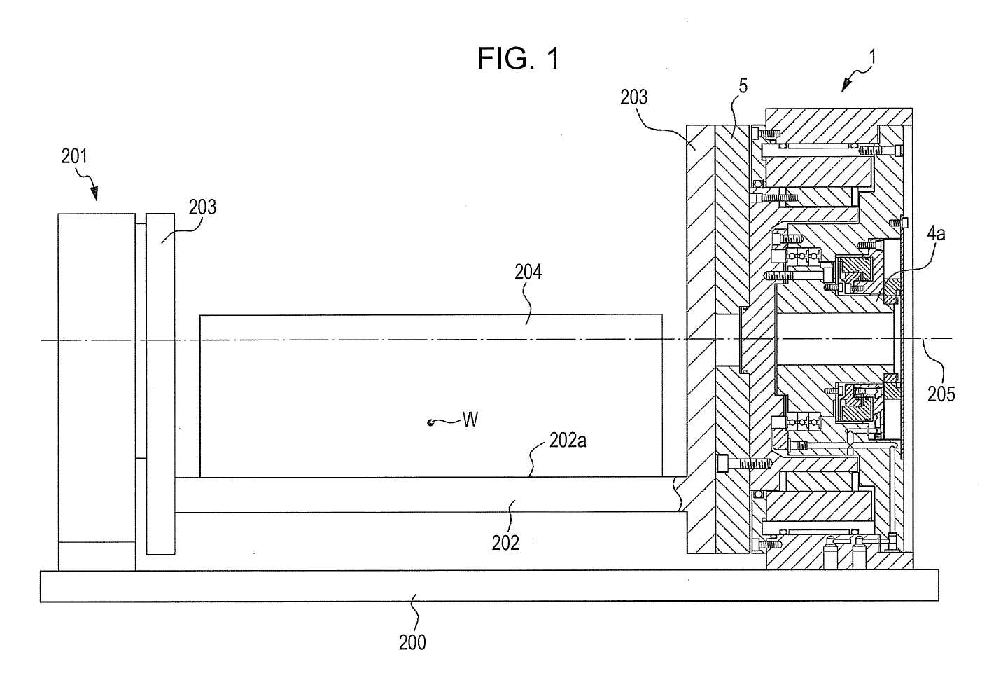

As shown in FIG. 1, a cradle indexing apparatus according to this embodiment includes a rotary table device 1, a support device 201, and a cradle 202. The rotary table device 1 and the support device 201 are mounted on a common base 200. The cradle 202 is supported by the rotary table device 1 and the support device 201 through a pair of arms 203. A jig and a workpiece 204, which is a processing target, are placed on a mount surface 202a of the cradle 202. The rotary table device 1 is vertically installed such that the rotation axis 205 of the main shaft 4a extends in the substantially horizontal direction. In this embodiment, a rotation target member is the circular table 5 of the rotary table device 1. The cradle 202, the arm 203, the jig, and the workpiece 204 are members to be rotated.

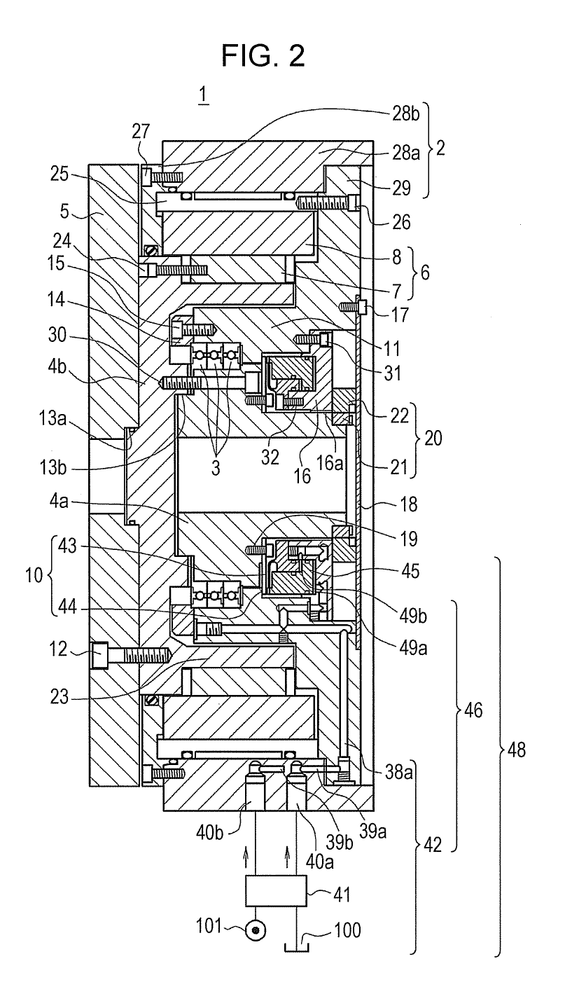

FIG. 2 illustrates a configuration example of the rotary table device 1 according to this embodiment shown in FIG. 1. The rotary table device 1 of this embodiment includes a rotational resistance applying device 10 that applies a rotational resistance to the main shaft 4a.

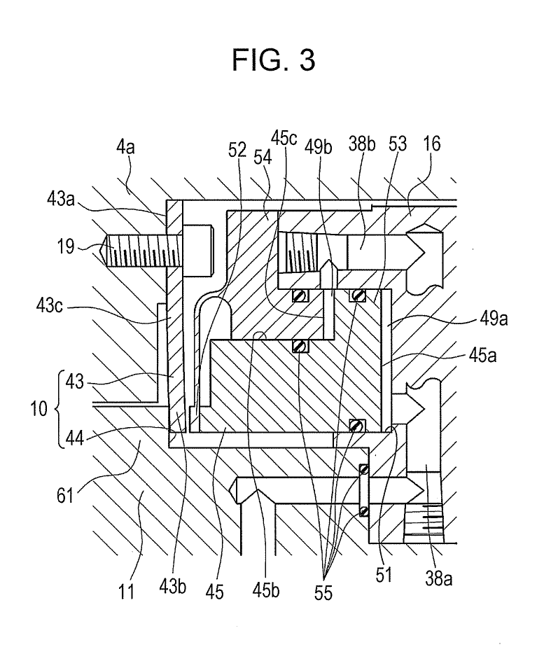

FIG. 3 illustrates a configuration example of part of the rotational resistance applying device 10 according to this embodiment. The rotational resistance applying device 10 of this embodiment is a disk rotational resistance applying device that presses a portion (a pressing portion 43b) of a disk-shaped slide disk 43, which is attached to the main shaft 4a, to a friction surface 44 provided at a frame 2 and hence causes a pressing force, which applies a rotational resistance to the main shaft 4a, to normally act on the friction surface 44.

First, a configuration of the rotary table device 1 will be described with reference to FIG. 2. As shown in FIG. 2, the rotary table device 1 includes the frame 2, the main shaft 4a that is supported rotatably relative to the frame 2, a flange 4b, the circular table 5 serving as the rotation target member, a DD motor 6 serving as a drive that rotationally drives the main shaft 4a, and a clamp device 48 that applies a rotational resistance to the main shaft 4a. The flange 4b and the circular table 5 are attached to the main shaft 4a.

The frame 2 is formed such that a mount surface thereof with respect to a machine tool is a flat surface. The frame 2 includes casing members 28a and 28b, and a base member 29 as separate members, and the separate members are assembled by a plurality of attachment bolts 27. The base member 29 includes a cylindrical base section 11 that surrounds the main shaft 4a. Alternatively, the cylindrical base section 11 may be formed as a separate member, and may be attached by a bolt or the like.

The main shaft 4a is inserted into the cylindrical base section 11 in the frame 2, and is supported by a bearing 3 rotatably relative to the frame 2. The flange 4b is attached to one end of the main shaft 4a. The circular table 5 is attached to the flange 4b. Also, the other end of the main shaft 4a is inserted into a hole 16a of a disk-shaped protruding member 16, and protrudes from the hole 16a. The protruding member 16 is attached to an inner periphery of the base member 29 by a plurality of attachment bolts 31.

The circular table 5 is attached to the flange 4b by a plurality of attachment bolts 12 such that a center hole 13a of the circular table 5 is fitted onto and positioned with respect to a protrusion of the flange 4b.

The flange 4b is attached to an end surface of the main shaft 4a by a plurality of bolts 30 such that a center hole 13b of the flange 4b is fitted onto and positioned with respect to the one end of the main shaft 4a. The flange 4b is integrally formed with a cylindrical holding section 23 that extends in the direction along the rotation axis of the main shaft 4a from a surface of the flange 4b located opposite to the circular table 5. Thus, the holding section 23 surrounds the base section 11. The holding section 23 is integrally formed with the flange 4b; however, the holding section 23 may be separately formed and may be attached to the flange 4b. Alternatively, the holding section 23 may not be provided at the flange 4b, and may be integrally formed with the circular table 5 or the main shaft 4a, or may be separately formed and attached thereto. Still alternatively, the circular table 5 and the flange 4b may be integrally formed, and the flange 4b and the main shaft 4a may be integrally formed.

The main shaft 4a is supported by the bearing 3 provided between an outer peripheral surface of the main shaft 4a and an inner peripheral surface of the base section 11. In the example shown in FIG. 2, three bearings 3 are combined for supporting the main shaft 4a. An inner ring side of the bearings 3 is fixed relative to the main shaft 4a such that the bearings 3 are pinched by a step portion that is formed at the outer peripheral surface of the main shaft 4a and a portion surrounding the center hole 13b of the flange 4b. Also, an outer ring side of the bearings 3 is fixed relative to the base section 11 such that the bearings 3 are pinched by a step portion that is formed at the inner peripheral surface of the base section 11 and a ring-shaped bearing holder 14 that is attached to an end surface of the base section 11 by an attachment bolt 15.

Also, the slide disk 43 is attached to the main shaft 4a. The slide disk 43 is an elastically deformable member formed of a disk-shaped thin plate, and has a through hole through which the main shaft 4a passes. The slide disk 43 is fixed to the main shaft 4a by an attachment bolt 19 at an inner peripheral portion of the slide disk 43. The slide disk 43 will be described later in more detail with reference to FIG. 3.

Further, a ring to be detected 21 is attached to the main shaft 4a at the other end of the protruding member 16 protruding from the hole 16a. The ring to be detected 21 defines part of a rotation detector 20. The rotation detector 20 detects a rotation angle (a rotation amount) of the main shaft 4a, and includes the ring to be detected 21 attached to the main shaft 4a and a detection sensor 22 attached to the protruding member 16 provided at the frame 2. An outer peripheral space of the main shaft 4a at the other end of the main shaft 4a provided with the rotation detector 20 is closed by a cover member 18. The cover member 18 is attached to the base member 29 by an attachment bolt 17.

The main shaft 4a is rotationally driven by a drive. The DD motor 6 is employed as the drive. The DD motor 6 rotationally drives the main shaft 4a without a transmission member such as a gear. The DD motor 6 is coaxially arranged with the main shaft 4a for the rotation axis of the main shaft 4a. The DD motor 6 includes a motor rotor 7 and a motor stator 8. That is, the DD motor 6 is so-called inner rotor type. The DD motor 6 is connected with a controller of a machine tool (not shown). The controller controls driving of the DD motor 6.

The motor rotor 7 is attached to the flange 4b by an attachment bolt 24 inserted from the flange 4b side non-rotatably relative to the flange 4b such that the motor rotor 7 is fitted on an outer peripheral surface of the holding section 23 of the flange 4b. Accordingly, the motor rotor 7 is non-rotatable relative to the main shaft 4a to which the circular table 5 is fixed.

The motor stator 8 is arranged to surround an outer peripheral surface of the motor rotor 7. In particular, the motor stator 8 is attached to the frame 2 such that an inner peripheral surface of the motor stator 8 faces the outer peripheral surface of the motor rotor 7 and that a slight gap is formed between the inner peripheral surface of the motor stator 8 and the outer peripheral surface of the motor rotor 7. Also, the motor stator 8 is fitted to an inner peripheral surface of a stator sleeve 25 non-rotatably relative to the stator sleeve 25. The stator sleeve 25 is attached to the frame 2 by an attachment bolt 26 inserted from the base member 29 side of the frame 2 such that the stator sleeve 25 is fitted on an inner peripheral surface of the casing member 28a of the frame 2. Accordingly, the motor stator 8 is arranged in the frame 2 non-rotatably relative to the frame 2.

The clamp device 48 includes a ring-shaped clamp piston 45 and a pressing force applying device 46. The pressing force applying device 46 includes a working fluid supply mechanism 42 and first and second pressure chambers 49a and 49b.

The working fluid supply mechanism 42 includes first and second ports 40a and 40b that are formed to be open toward an outer surface of the casing member 28a of the frame 2, first and second communication paths 39a and 39b that are formed in the casing member 28a, first and second flow paths (FIG. 2 illustrates only a first flow path 38a) that are formed in the base member 29 of the frame 2, a working fluid supply source 101 for supplying a working fluid (for example, a pressure oil), a tank 100 for the working fluid, and a fluid supply device 41 that is connected with the working fluid supply source 101.

The first flow path 38a and the first communication path 39a connected therewith allow the first pressure chamber 49a and the first port 40a to communicate with each other. The first port 40a is connected with the fluid supply device 41 that is provided separately from the frame 2. Also, the second flow path (not shown) and the second communication path 39b connected therewith allow the second pressure chamber 49b and the second port 40b to communicate with each other. The second port 40b is connected with the fluid supply device 41.

The fluid supply device 41 includes a changeover valve (not shown) controlled by the controller of the machine tool. One side of the changeover valve is connected with the working fluid supply source 101 and the tank 100 through the flow path, and the other side thereof is connected with the first and second ports 40a and 40b through the flow path. The fluid supply device 41 serves as a power unit for driving the clamp piston 45. The fluid supply device 41 supplies the working fluid with a predetermined pressure supplied from the common working fluid supply source 101 selectively to at least one of the first and second pressure chambers 49a and 49b by selecting the first port 40a or the second port 40b by the changeover valve.

Also, as shown in FIG. 3, the clamp piston 45 of the clamp device 48 is housed in a ring-shaped guide groove 51 that is formed in the protruding member 16 of the frame 2 such that the clamp piston 45 is movable in the axial direction relative to the guide groove 51. The guide groove 51 is formed to be open toward the slide disk 43, at a portion of the protruding member 16 of the frame 2 facing the slide disk 43. Accordingly, an end surface, which is near the circular table 5, (or an end surface, which is near the slide disk 43,) of the clamp piston 45 housed in the guide groove 51 faces the slide disk 43. Also, a return disk 52 is arranged between the end surface, which is near the slide disk 43, of the clamp piston 45 and the slide disk 43.

The return disk 52 is an elastically deformable member formed of a substantially doughnut-shaped thin plate. The return disk 52 is fixed non-rotatably relative to the base member 29 through a flange member 54 and the protruding member 16. Accordingly, the clamp piston 45 is prevented from being rotated by rotation of the slide disk 43. When a pressing force by the working fluid from the fluid supply device 41 does not act on the clamp piston 45, the return disk 52 is not in contact with the slide disk 43. In contrast, when the pressure by the working fluid from the fluid supply device 41 acts on the clamp piston 45, the return disk 52 presses the slide disk 43 and transmits the pressing force of the clamp piston 45 to the slide disk 43.

The clamp piston 45 includes a ring-shaped protruding portion 53 that is formed at a lower end of an inner peripheral portion of the clamp piston 45 and that protrudes toward the inner periphery side. The ring-shaped flange member 54 is attached to an end surface, which is near the slide disk 43, of the protruding member 16 of the frame 2 by an attachment bolt 32 at a position between the protruding portion 53 and the slide disk 43 (see FIG. 2). An outer peripheral surface of the flange member 54 is in closely contact with an inner peripheral surface of the clamp piston 45 with a seal 55 arranged therebetween.

The base section 11 of the base member 29 that defines part of the frame 2 has a step portion 61 that protrudes from an inner peripheral surface of the base section 11 toward the inside in the radial direction. A lower surface, which is a surface opposite to the circular table 5, of the step portion 61 faces a surface, which is near the circular table 5, of the pressing portion 43b. The pressing portion 43b is located at an end portion near the outer periphery of the slide disk 43. The lower surface of the step portion 61 functions as the friction surface 44 that can come into contact with the pressing portion 43b of the slide disk 43. To restrict wearing, a sliding member (for example, Turcite B-Slydway (registered trademark)) may be bonded on the slide disk 43 or the friction surface 44.

The slide disk 43 fixed to the main shaft 4a is the elastically deformable member formed of the disk-shaped thin plate as described above. The slide disk 43 has a through hole through which the main shaft 4a passes. The slide disk 43 is fixed to the main shaft 4a at a fixed portion 43a thereof located at an end portion near the through hole such that the pressing portion 43b located at the end portion near the outer periphery faces the friction surface 44.

In the clamp device 48, a space surrounded by a lower end surface 45a, which is an end surface opposite to the slide disk 43, of the clamp piston 45 and the guide groove 51 defines the first pressure chamber 49a for clamping. When the working fluid with the predetermined pressure is supplied to the first pressure chamber 49a by the working fluid supply mechanism 42 of the pressing force applying device 46, the lower end surface 45a of the clamp piston 45 receives a pressing force corresponding to the pressure, and hence the clamp piston 45 presses the slide disk 43 through the return disk 52. As the result, the slide disk 43 fixed to the main shaft 4a becomes pinched (clamped) between the clamp piston 45 (the return disk 52) and the friction surface 44 provided at the frame 2, and hence the main shaft 4a becomes clamped.

The clamped state mentioned above is a state in which a rotational resistance that inhibits the main shaft 4a from rotating is applied to the main shaft 4a to cause the main shaft 4a to be non-rotatable, and hence the clamped state is complete clamping. In contrast, half clamping is a state in which the pressing force that applies the rotational resistance acts on the main shaft 4a in a range that permits rotation of the main shaft 4a. Since the half clamping permits the rotation of the main shaft 4a, the indexing apparatus (the rotary table device 1) can perform indexing etc. for the angular position without any problem.

Also, in the clamp device 48, a space surrounded by an inner peripheral surface 45b of the clamp piston 45, a surface 45c, which is near the slide disk 43, of the protruding portion 53 of the clamp piston 45, the flange member 54, and an inner peripheral surface of the guide groove 51 defines the second pressure chamber 49b for unclamping. When the working fluid to the first pressure chamber 49a by the above-described working fluid supply mechanism 42 is stopped and the working fluid with the predetermined pressure is supplied to the second pressure chamber 49b, the surface 45c, which is near the slide disk 43, of the protruding portion 53 of the clamp piston 45 receives a pressing force corresponding to the pressure, and the clamp piston 45 moves away from the slide disk 43. Consequently, the complete clamping is released, and the main shaft 4a becomes rotatable.

With the above-described rotary table device 1, according to this embodiment, the slide disk 43 of the clamp device 48 functions as the above-mentioned rotational resistance applying device 10. In other words, in this embodiment, a partial configuration of the clamp device 48 also functions as the rotational resistance applying device 10.

The slide disk 43 includes as an integrated member the fixed portion 43a, the pressing portion 43b serving as a pressing member, and an elastically deformable portion 43c serving as an elastic member located between the fixed portion 43a and the pressing portion 43b. The elastically deformable portion 43c functions as an urging portion. Regarding the slide disk 43, the fixed portion 43a is attached to the main shaft 4a such that the elastically deformable portion 43c is bent (elastically deformed) in an area between a portion of the frame 2 near the base section 11 and a portion of the frame 2 near the main shaft 4a, and the pressing portion 43b urges the friction surface 44 by a bending force (an elastic force) of the elastically deformable portion 43c. Accordingly, the pressing portion 43b normally presses the friction surface 44, so that the pressing force for half clamping for applying the rotational resistance that permits the rotation of the main shaft 4a normally acts on the main shaft 4a.

To be more specific, an attachment surface of the main shaft 4a to which the slide disk 43 is attached is shifted to the upper side in the axial direction of the main shaft 4a with respect to the friction surface 44 (toward a member of the friction surface 44). Consequently, the elastically deformable portion 43c of the flat-plate-shaped slide disk 43 becomes bent in an area between the attachment surface and the friction surface 44, and the pressing portion 43b is urged and presses the friction surface 44 by the bending force (the elastic force). Here, the shift represents a state in which two planes are parallel to each other at a constant distance in a direction perpendicular to the planes (the same can be said hereinafter). The shift amount is determined such that the elastic force, which acts on the pressing portion 43b to press the friction surface 44 in accordance with elastic deformation of the elastically deformable portion 43c, applies a sliding resistance that is generated between the pressing portion 43b and the friction surface 44 and that permits the rotation of the main shaft 4a (or that does not completely clamp the main shaft 4a).

With the cradle indexing apparatus in FIG. 1, the position of the center of gravity W of the entire configuration including the members to be rotated (the cradle 202, arm 203, jig, and workpiece 204) attached to the rotation target member is deviated from the rotation axis 205 of the main shaft 4a.

In the rotational resistance applying device 10, the pressing portion 43b of the slide disk 43 attached to the main shaft 4a urges the friction surface 44 by the bending force (the elastic force) of the elastically deformable portion 43c and presses the friction surface 44. Accordingly, the pressing force for half claming for applying the rotational resistance that permits the rotation of the main shaft 4a normally acts on the main shaft 4a. Consequently, the rotational resistance (a braking force) for half clamping is normally applied to the main shaft 4a even when the main shaft 4a is not completely clamped.

Hence, even in the case in which the position of the center of gravity W of the entire configuration including the members to be rotated attached to the rotation target member is deviated from the rotation axis 205 of the main shaft 4a and the deviation of the center of gravity W causes a force in the rotation direction to act on the main shaft 4a when power feed is stopped, since the rotational resistance normally acts on the main shaft 4a, the main shaft 4a is prevented from being freely rotated at high speed while the rotational resistance does not properly act, and a workpiece or a tool can be prevented from being broken.

Also, with this embodiment, since the pressing member and the urging portion are formed of the single member, the configuration of the pressing force applying device for applying the pressing force for half clamping to the main shaft 4a can be simplified, and consequently, the rotary table device 1 can be decreased in size and manufacturing cost.

In addition, with this embodiment, since the slide disk 43, which is part of the clamp device 48, functions as the rotational resistance applying device 10, a special mechanism for the pressing force applying device does not have to be provided. The rotary table device 1 can be decreased in size and manufacturing cost.

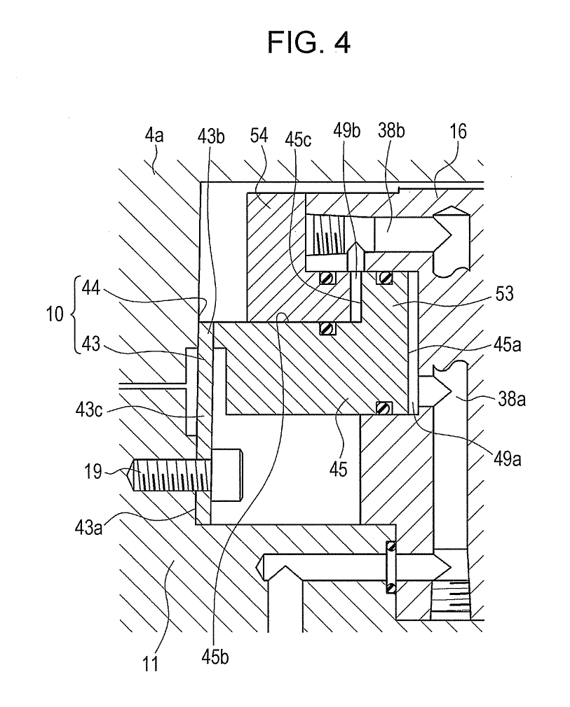

Like the above-described embodiment, when the rotational resistance applying device 10 uses the slide disk 43, in the example shown in FIG. 3, the slide disk 43 is provided at the main shaft 4a and the friction surface 44 is provided at the frame 2. Alternatively, as shown in FIG. 4, a slide disk 43 may be provided at the frame 2, and a friction surface 44 may be provided at the main shaft 4a. However, in the example of FIG. 4, a rotation preventing mechanism (not shown) is provided at the clamp piston 45, and the return disk 52 is not provided.

In FIG. 4, the slide disk 43 includes a pressing portion 43b that is located at an end portion near the through hole and that faces the friction surface 44, a fixed portion 43a that is located at an end portion near the outer periphery and that is fixed to the base section 11 of the frame 2, and an elastically deformable portion 43c serving as an elastic member that is located between the pressing portion 43b and the fixed portion 43a.

In the above-described embodiment, the flat-plate-shaped slide disk 43 is provided, and the position of the attachment surface, to which the fixed portion 43a is attached, is shifted from the position of the friction surface 44. However, the invention is not limited thereto. For example, the slide disk 43 may have a preparatorily curved sectional shape in the radial direction, may be configured such that a surface of the pressing portion 43b facing the friction surface 44 is shifted toward the member of the friction surface 44 from the friction surface 44 with reference to the attachment surface of the fixed portion 43a, and may be attached in a bent state in an area between the friction surface 44 and the attachment surface. In this case, the position of the attachment surface, to which the fixed portion 43a is attached, and the position of the friction surface 44 may not be shifted from each other, or may be shifted from each other.

In the above-described embodiment, the surfaces of the respective members opposite to the circular table 5 are provided as the friction surface 44. However, it is not limited thereto. For example, surfaces, which are near the circular table 5, of the step portion 61 and the main shaft 4a may be provided as the friction surface 44, or a surface, which is near the frame 2, of the circular table 5 may be provided as the friction surface 44.

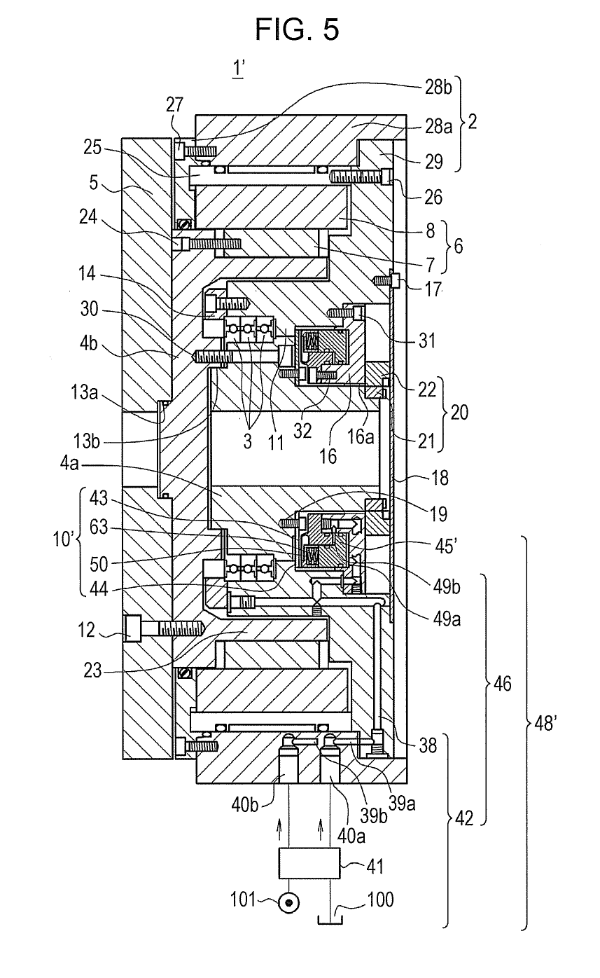

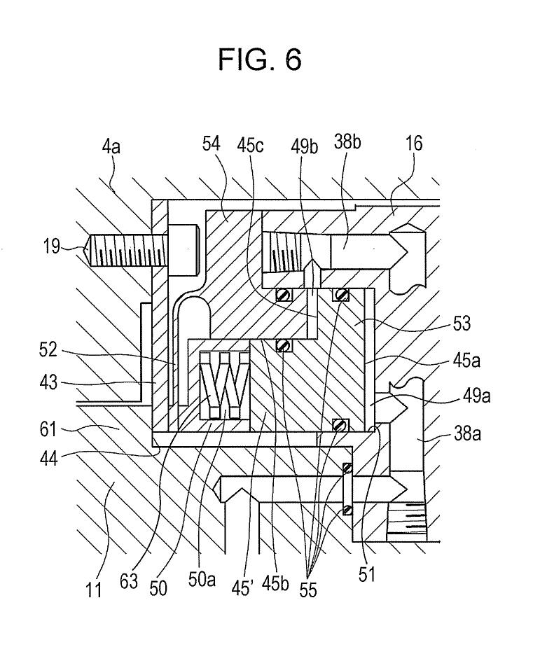

Next, another embodiment of the invention will be described with reference to the drawings. FIGS. 5 and 6 illustrate configuration examples of a rotary table device 1′ and a rotational resistance applying device 10′ according to the another embodiment. Reference numerals in FIGS. 5 and 6 refer like components as in FIGS. 2 and 3, and hence redundant description will be omitted.

The rotary table device 1′ shown in FIG. 5 is similar to the rotary table device 1 shown in FIG. 2 except for a clamp device 48′. Also, the clamp device 48′ the detail of which is shown in FIG. 6 has a structure that is basically similar to that of the clamp device 48 shown in FIG. 3. However, a portion corresponding to the clamp piston 45 of the clamp device 48 is formed of two members including a clamp piston 45′ and a piston 50.

Also, as shown in FIG. 6, in the clamp device 48′, a slide disk 43 is a substantially flat plate that is not curved in the radial direction like the clamp device 48, but the attachment surface, to which the slide disk 43 is attached, provided at the main shaft 4a and the friction surface 44 provided at the frame 2 are not shifted from each other. Hence, when the slide disk 43 does not receive the pressing force, the slide disk 43 is a substantially flat plate without being bent.

In the rotary table device 1′ including the clamp device 48′, according to this embodiment, the slide disk 43 of the rotational resistance applying device 10′ functions as a pressing member and the piston 50 functions as part of an urging portion. That is, even in this embodiment, although part of the clamp device 48′ functions as the rotational resistance applying device 10′, this embodiment differs from the embodiment in FIG. 3 in that the urging portion is provided separately from the pressing member. The detail is as follows.

The piston 50 is a ring-shaped member provided between the clamp piston 45′ and a return disk 52. The piston 50 can slide in the direction along the rotation axis of the main shaft 4a by a flange member 54 in an area between the clamp piston 45′ and the return disk 52. The piston 50 has a plurality of holes 50a in a surface near the clamp piston 45′. The holes 50a are arranged at predetermined intervals in the circumferential direction. A spring member 63 is provided in each of the holes 50a to cause a pressing force by the piston 50 to act on the slide disk 43. Hence, the piston 50 and the spring member 63 define the urging portion.

The spring member 63 is a compression spring and causes an urging force (an elastic force) toward the slide disk 43 to act on the piston 50. The spring member 63 is compressed even when clamping by the clamp device 48′ for the main shaft 4a (clamping by the slide disk 43) is not provided, i.e., when a hydraulic pressure does not act on an end surface 45a of the clamp piston 45′, and the spring member 63 causes an urging force to act on the piston 50. Also, a sliding resistance that is generated between the slide disk 43 and the friction surface 44 as the result of a pressing force that acts on the slide disk 43 by the urging force (the elastic force) by the compressed spring member 63 is determined to permit the rotation of the main shaft 4a (i.e., does not completely clamp the main shaft 4a).

As described above, with this rotational resistance applying device 10′, the pressing force normally acts on the slide disk 43 attached to the main shaft 4a, by the elastic force of the spring member 63, through the piston 50. Hence, the slide disk 43 normally presses the friction surface 44. Accordingly, the pressing force for half claming for applying the rotational resistance that permits the rotation of the main shaft 4a normally acts on the main shaft 4a. Consequently, the rotational resistance (the braking force) for half clamping is normally applied to the main shaft 4a even when the main shaft 4a is not completely clamped.

With this embodiment, by providing the plurality of spring members 63 at the predetermined intervals in the circumferential direction, the slide disk 43 can press the friction surface 44 further evenly in the circumferential direction.

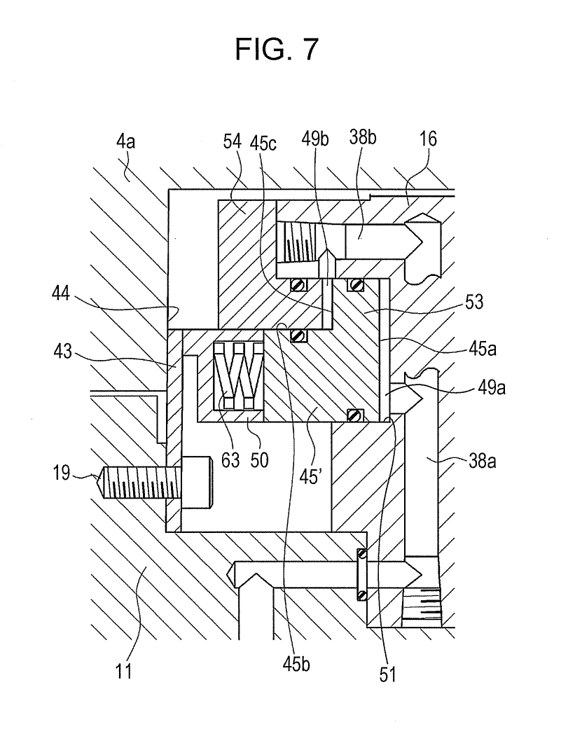

In the embodiment shown in FIGS. 5 and 6, the return disk 52 is provided. However, the invention is not limited thereto. For example, as shown in FIG. 7, the return disk 52 may be omitted, and a rotation preventing mechanism (not shown) may be provided at the piston 50 for half clamping or the clamp piston 45′ for complete clamping.

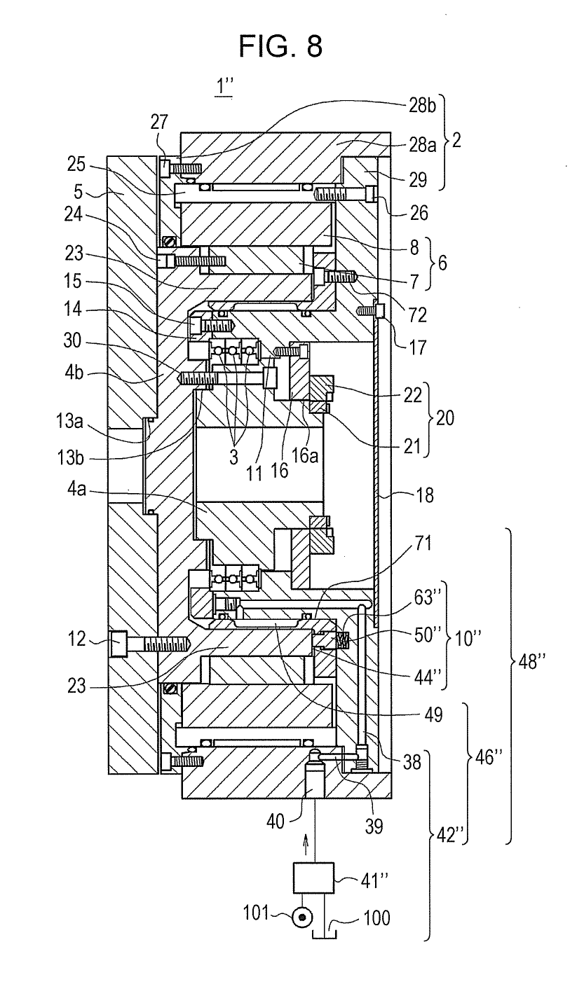

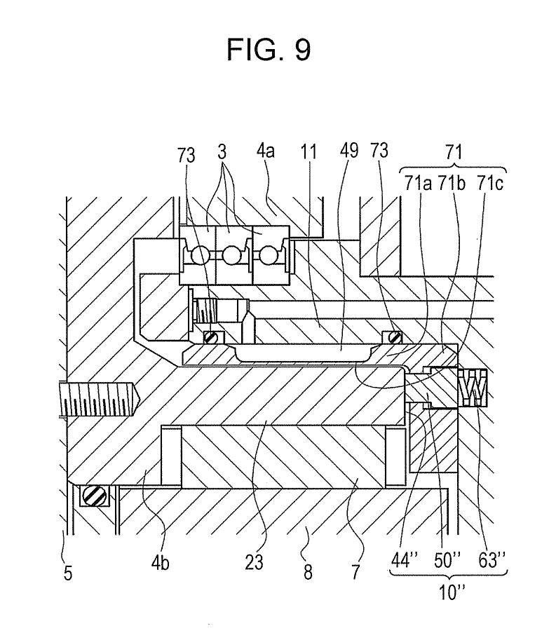

Next, still another embodiment of the invention will be described with reference to the drawings. FIGS. 8 and 9 illustrate configuration examples of a rotary table device 1″ and a rotational resistance applying device 10″ according to the still another embodiment. Reference numerals in FIGS. 8 and 9 refer like components as in FIGS. 2 and 3, and hence redundant description will be omitted.

The rotary table device 1″ of this embodiment differs from the rotary table device 1 in FIG. 2 etc. in that a sleeve clamp device 48″ is provided as a clamp device. The sleeve clamp device 48″ is a known clamp device and includes a clamp sleeve 71 and a working fluid supply mechanism 42″.

The clamp sleeve 71 includes a cylindrical clamp portion 71a arranged between a base section 11 of a frame 2 and a holding portion 23 of a flange 4b provided at a main shaft 4a, and a flange portion 71b that extends from the clamp portion 71a in the radial direction. The clamp portion 71a is fitted on the outer side of the base section 11, and the flange portion 71b is attached to the base member 29 of the frame 2 by an attachment bolt 72. The clamp portion 71a is arranged such that an outer peripheral surface of the clamp portion 71a faces an inner peripheral surface of the holding portion 23 in a non-contact state, and an inner peripheral surface of the clamp portion 71a is in closely contact with an outer peripheral surface of the base section 11 through two seals 73.

The clamp portion 71a of the clamp sleeve 71 has a groove in the inner peripheral surface of the clamp portion 71a. A portion of the clamp sleeve 71 corresponding to the groove serves as a thin portion 71c with a small thickness. A space surrounded by an inner surface of the groove and the outer peripheral surface of the base section 11 defines a pressure chamber 49 to which a working fluid is supplied.

The working fluid supply mechanism 42″ includes a port 40 that is formed in a casing member 28a of the frame 2, a communication path 39 that is formed in the casing member 28a, a flow path 38 that is formed in the base member 29 of the frame 2, a working fluid supply source 101 for supplying the working fluid to the clamp sleeve 71, a tank 100 for the working fluid, and a fluid supply device 41″ that is connected with the working fluid supply source 101.

The pressure chamber 49 is connected with the fluid supply device 41″ through the flow path 38, the communication path 39, and the port 40. In the clamp device 48″, when the working fluid is supplied from the fluid supply device 41″ to the pressure chamber 49, the diameter of the thin portion 71c of the clamp sleeve 71 is increased by a hydraulic pressure, a resulting pressing force acts on the holding portion 23 provided at the main shaft 4a, and consequently the main shaft 4a becomes completely clamped.

According to this embodiment, the rotary table device 1″ including the clamp device 48″ includes the rotational resistance applying device 10″ having a piston 50″ that is provided separately from the clamp device 48″ (the clamp sleeve 71) and that serves as a pressing member, and a spring member 63″ that serves as an urging portion.

In particular, the rotational resistance applying device 10″ is a piston rotational resistance applying device 10″ that normally presses the piston 50″ to a friction surface 44″ provided at the main shaft 4a and hence causes a pressing force to act as the result of urging by the spring member 63″ provided at the base section 11 provided at the frame 2. In this embodiment, an end surface of the holding portion 23 of the flange 4b functions as the friction surface 44″.

In the rotational resistance applying device 10″, the piston 50″ serving as the pressing member is housed movably in the axial direction in each of a plurality of through holes that are formed in the flange portion 71b of the clamp sleeve 71 in the circumferential direction and penetrate through the flange portion 71b in the axial direction.

The spring member 63″ serving as the urging portion is housed in each of a plurality of holes that are provided in the base section 11 and respectively correspond to the through holes in the clamp sleeve 71. The spring member 63″ is a compression spring, is provided in a compressed state between a bottom surface of the hole of the base section 11 and an end surface of the piston 50″. The spring member 63″ normally urges the piston 50″ in a pressing direction toward the friction surface 44″ by an elastic force. The spring member 63″ has an elastic force that acts on the piston 50″ for half clamping to press the friction surface 44″ in accordance with elastic deformation of the spring member 63″. The pressing force is determined such that a sliding resistance generated between the piston 50″ and the friction surface 44″ by the pressing force applied by the piston 50″ to the friction surface 44″ as the result of the elastic force in the compressed state permits the rotation of the main shaft 4a (i.e., does not completely clamp the main shaft 4a).

Accordingly, with the thus-configured rotational resistance applying device 10″, the pressing force for half claming for applying the rotational resistance that permits the rotation of the main shaft 4a normally acts on the main shaft 4a by the piston 50″ through the clamp sleeve 71. Consequently, the rotational resistance (the braking force) for half clamping is normally applied to the main shaft 4a even when the main shaft 4a is not completely clamped.

Also, with this embodiment, by providing the plurality of spring members 63″ at the predetermined intervals in the circumferential direction, the piston 50″ can press the friction surface 44″ further evenly in the circumferential direction.

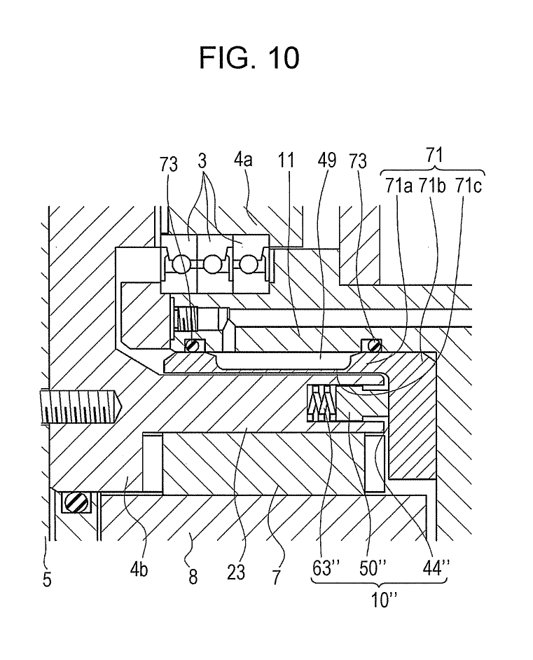

In the embodiment in FIGS. 8 and 9, the piston 50″ and the spring member 63″ are provided at the frame 2 and the friction surface 44″ is provided at the main shaft 4a. Alternatively, as shown in FIG. 10, the piston 50″ and the spring member 63″ may be provided at the main shaft 4a, and the friction surface 44″ may be provided at the frame 2.

In this case, an upper end surface of the flange portion 71b of the clamp sleeve 71 functions as the friction surface 44″. Also, a plurality of holes may be provided in the circumferential direction in a lower end surface of the holding portion 23 of the main shaft 4a (the flange 4b), and the pistons 50″ are respectively housed in the holes movably in the axial direction, and the spring members 63″ that urge the pistons 50″ in the axial direction are respectively housed in the holes. The spring member 63″ is a compression spring, and normally urges the piston 50″ in the pressing direction toward the friction surface 44″.

Also, described in the above-described embodiments is an example when the invention is applied to a rotary table device vertically installed as part of a cradle indexing apparatus. However, the invention is not limited thereto. For example, the invention may be applied to an indexing apparatus of a type in which a jig and a workpiece are directly attached to a circular table of a rotary table device that is vertically installed, a tilting indexing apparatus of a tilting table, or an indexing apparatus with a rotating shaft to which a workpiece is fixed.

Also, described in the above-described embodiments is the example configuration of the rotary table including the clamp device and the rotational resistance applying device is described. However, the invention is not limited thereto. A rotational resistance applying device may be solely provided at an indexing apparatus for a machine tool without a clamp device.

The above-described embodiments are merely examples for implementing the present invention, and the technical scope of the invention should not be interpreted in a limited way by the embodiments. That is, the invention can be implemented in various forms without departing from features of the invention.

What is claimed is:

1. An indexing apparatus for a machine tool, comprising:
a frame;
a main shaft that is supported rotatably relative to the frame;
a direct drive motor that rotationally drives the main shaft; and
a rotational resistance applying device that applies a rotational resistance to the main shaft, the rotational resistance permitting rotation of the main shaft,
wherein the rotational resistance applying device includes
a friction surface that is provided at one of the frame and the main shaft,
a pressing member that is provided at the other one of the frame and the main shaft to face the friction surface, and
an urging portion that urges the pressing member to the friction surface and hence causes the pressing member to normally press the friction surface.

2. The indexing apparatus for the machine tool according to claim 1, wherein the urging portion includes an elastic member that is provided in an elastically deformed state, and the urging portion urges the pressing member to the friction surface by using an elastic force of the elastic member.

3. The indexing apparatus for the machine tool according to claim 2,
wherein the rotational resistance applying device includes a disk-shaped slide disk that is formed of an elastically deformable member and has a through hole through which the main shaft passes, and
wherein the slide disk includes
a pressing portion serving as the pressing member that is located at one of an end portion near an outer periphery and an end portion near the through hole and faces the friction surface,
a fixed portion that is located at the other one of the end portion near the outer periphery and the end portion near the through hole and is fixed at the other one of the frame and the main shaft, and
an elastically deformable portion serving as the elastic member that is located between the pressing portion and the fixed portion.

4. The indexing apparatus for the machine tool according to claim 2, wherein the elastic member is a spring member that is provided in an elastically deformed state.
